(19) United States
(12) Patent Application Publication
(10) Pub. No.: US 2026/0149407 A1
(43) Pub. Date: May 28, 2026

(54) MODULE HOLDER AND ASSOCIATED PHOTOVOLTAIC SYSTEM

(71) Applicant: Next2Sun Technology GmbH, Dillingen (DE)

(72) Inventors: Peter BENDIX, Dillingen (DE); Heiko HILDEBRANDT, Dillingen (DE); Florian HOFF, Dillingen (DE); Thomas SCHNEIDER, Dillingen (DE); Stefan OLLINGER, Dillingen (DE)

(73) Assignee: Next2Sun Technology GmbH, Dillingen (DE)

(21) Appl. No.: 19/119,941

(22) PCT Filed: Oct. 11, 2023
(86) PCT No.: PCT/EP2023/078205

§ 371 Date: Apr. 10, 2025

(30) Foreign Application Priority Data
Oct. 14, 2022 (DE) 102022127018.1

(51) Int. Cl. H02S 30/10; F16M 13/02

(52) U.S. Cl. CPC H02S 30/10; F16M 13/02

(57) ABSTRACT

In order to securely hold an upright photovoltaic (PV) module (2), an associated sufficiently strong module holder (6) is provided, which can stabilize one or more outer edges of the PV module (2) against wind loads and at the same time minimizes the susceptibility of the PV module (2) to shading by the associated module holder (6). The module holder (6) has a convex shape, allowing large maximum shading-free angles of incidence (23, 24) at the front and rear and simultaneously achieving the lowest possible respective lateral expansion of the module holder (6) in a direction transverse to an active surface (9) of the PV module (2), namely both at the front and rear. This makes it possible to obtain powerful PV systems (1), based on a support structure (3), which, using the present module holders (6), hold large-surface-area bifacial PV modules (2) upright and in a largely shading-free manner.

### CROSS-REFERENCE TO RELATED APPLICATIONS

This application is a 371 National Phase of International Application No. PCT/EP 2023/078205, filed Oct. 11, 2023, which claims priority from German Patent Application No. 10 2022 127 018.1, filed Oct. 14, 2022, both of which are incorporated herein in their entirety as if fully set forth.

### TECHNICAL FIELD

The invention relates to a module holder together with an associated bifacial photovoltaic (PV) module, which together can be regarded as a (mounting) set. Here, the photovoltaic module has an active surface which can receive sunlight from a front side and from a rear side of the photovoltaic module in order to convert the sunlight into electrical current. The module holder, on the other hand, provides a receptacle into which an outer edge of the photovoltaic module is inserted in an insertion direction and thus held in position. In relation to a plane of the active surface of the photovoltaic module, the receptacle is delimited at the front by a front leg and/or at the rear by a rear leg of the module holder.

The invention also relates to a photovoltaic system with a plurality of bifacial PV modules which are arranged upright (i.e., in vertical orientation) on a support structure.

### BACKGROUND

Such module holders are already known; however, they have so far mainly been used for monofacial PV modules that are installed in such a way that they can substantially only receive sunlight from one side.

For a photovoltaic system with a plurality of bifacial PV modules which are arranged upright (i.e., in vertical orientation) on a support structure, in this case, the support structure comprises a plurality of posts which are fastened to or in the ground, in particular anchored, wherein transoms are fastened to the posts, which in each case connect two adjacent posts to one another (directly or mediated by adapter elements). These transoms thus run substantially horizontally, while the posts run vertically. The module holder is designed to hold the PV module securely. The module holder can be attached to a transom and/or a post of a support structure of a PV system. In other words, the module holder can therefore be used to fasten the associated bifacial PV module to the support structure, in particular to at least one transom and/or at least one post of the support structure.

Such PV systems are also already in use to generate solar power. In such systems, the module plane, i.e., the plane in which the active surfaces of the PV modules are located, is often aligned in a north-south direction. This has the advantage that in the early morning hours, the PV modules can catch flat incident sunlight from easterly directions on their front side. In the evening hours, when the sunlight falls flat from a westerly direction, the bifacially designed PV modules can catch the sunlight on their rear side. As a result, a current curve of the solar power generated by the PV system can be obtained that shows a maximum before and after midday. The higher the sun is above the horizon, the steeper the angle of incidence of the sun's rays (in relation to the earth's surface), which fall on the front or rear of the respective PV module.

There is currently a tendency to install PV modules with ever larger surface areas, for example more than two square meters. For such large-surface-area PV modules, the problem with previous support structures based on posts that are connected to each other via transoms is that the respective PV module may bend so much under wind load that it can no longer be held securely on the transoms. Another ongoing trend is to continue to increase the efficiency of solar power production, as the generation of electricity from renewable energy sources is becoming increasingly valuable.

### SUMMARY

The invention has set itself the task of making a technical contribution to both problems. The invention is thus intended to provide a support structure that can safely absorb high wind loads, even with very large module sizes, while at the same time enabling high electrical efficiency of the PV system. For this purpose, a (mounting) set as described previously is to be provided, which can be integrated into the support structure, in order to arrange the PV modules within the support structure.

To solve this problem, one or more of the features disclosed herein are provided in accordance with the invention for a set comprising a module holder and an associated bifacially designed PV module. In particular, it is thus proposed for solving the problem in accordance with the invention in a set of the type mentioned at the outset that respective front and rear outer points of a cross-section of the module holder extending perpendicularly to a plane of the active surface are offset back in the insertion direction and with respect to respective module-side tips of the two legs. In this case, said outer points are those outer points of the cross-section of the module holder which are relevant for shading of the active surface caused by the module holder.

The axial offset of these outer points along the insertion direction to the respective tip of the front or rear leg can preferably be at least 1.2 times, preferably at least 1.5 times, or even at least 2.0 times, a minimum width of the receptacle. For example, in a module holder according to the invention with a minimum width (or insertion width) of the receptacle of 5 mm (this thus corresponds to a maximum thickness of the PV module at the edge, which can still be inserted into the receptacle), the axial offset of the outer points can be 11 mm, i.e., 11/5=2.2 times the minimum width of the receptacle.

In such embodiments, an envelope, which is relevant for the shading of the active surface by the module holder and which envelops an outer contour of the module holder, can thus exhibit a convex shape when viewed in the insertion direction. In other words, a lateral width of the envelope ends, transverse to a plane of the active surface, thus increases monotonically in the insertion direction. The envelope of the module holder thus has its smallest lateral width on the module side. In other words, the envelope of the module holder runs monotonously towards the PV module-against the insertion direction-both from the front and from the rear of the PV module. The shape of the envelope could be determined, for example, by placing a cloth or film over the module holder from the insertion direction and stretching it in the insertion direction. The envelope can thus define the contour relevant for the shading of the active surface, which limits the possible angle of incidence of the sun's rays on the active surface.

Such embodiments can minimize the shading effect of the module holder on the active surface of the bifacial PV module. In particular, freedom from shading of the active surface can be achieved up to lateral or vertical maximum shading-free angles of incidence of at least 110°, both in relation to the front and rear of the PV module. At the same time, the module holder can be designed with high mechanical strength so that the module holder can stabilize the unstable PV module, especially when high wind loads act on the PV module.

However, many of the module frames currently available on the market, if they are used to hold bifacial PV modules, lead to shading of the active surfaces on the rear side of the module, so that the shading resulting from the module frame has a significant performance-reducing effect on solar electricity production, particularly at a flat angle of incidence on the PV module.

In order to reduce the susceptibility to shading of the active surface when the maximum angle of incidence without shading is exceeded, it is also advantageous if the respective lateral distances that the outer points occupy from the plane of the active surface differ by less than 25%, preferably less than 15%. This is because a cross-section of the module holder can be obtained in which a respective lateral distance between the module plane and the module holder (often referred to as lateral cell plane frame distance) is minimized. This is advantageous because the smaller the lateral distance between the module plane and the module holder is selected, the smaller the shading length of the active surface (measured in the plane of the active surface) will be (depending on the angle of incidence of the sun's rays) if the maximum angle of incidence without shading is exceeded. This significantly reduces the susceptibility of the set to shading.

In particular, such designs can ensure that the maximum angle of incidence without shading (at which the sun's rays can reach the active surface from the front or rear), measured in relation to the active surface, is at least 120°, preferably even at least 135°.

A module holder according to the invention can be designed transversely to the insertion direction and transversely to a surface normal of the active surface (i.e., in a direction along the outer edge of the PV module), for example, more than three times longer than the depth of the module holder in the insertion direction. As a result, the receptacle can take the form of an elongate slot. The receptacle itself can be at least 1.5 times or even at least 2.0 times as deep in the insertion direction as a minimum width of the receptacle in the direction of a surface normal of the active surface. This ensures that the outer edge of the PV module is securely enclosed.

It should also be mentioned at this point that a module holder according to the invention can also be designed in two parts. In this case, a front part of the module holder can form the front leg of the receptacle and a rear part of the module holder can form the rear leg. The two parts can overlap along the outer edge of the PV module (in which case the PV module is held on both sides at least in the overlap area) or be spaced apart (in which case the outer edge of the PV module is held by the module holder on the front in sections and on the rear in sections). However, embodiments in which the respective module holder is formed in one piece and forms both a front and a rear leg of the receptacle are preferred.

Furthermore, a module holder according to the invention can also form two opposing receptacles, namely if the module holder is designed to connect two adjacent PV modules directly to each other. In this case, a respective PV module is inserted into each of the two receptacles.

The ratio between a maximum width of the module holder in the insertion direction and a maximum insertion depth of the receptacle can, for example, assume values between 1.20 and 2.80. A distance between the outer edge of the PV module and a stop inside the receptacle, which is formed by the module holder, can, for example, be 1-2 mm.

The module holder can also be used to stabilize a longitudinal or transverse side of the PV module, either in sections or completely. Depending on the design, the length of the receptacle can thus extend transversely to the insertion direction over the entire length of a longitudinal or transverse side of the PV module. In this case, the module holder thus encompasses the entire longitudinal or transverse side of the PV module.

The PV module held by the module holder can be designed in particular as a frameless laminate, especially as a glass laminate. In this case, the active surface can be integrated into the laminate. The active surface can, for example, only be covered on one side by a film.

Furthermore, the active surface can be arranged offset from a center plane of the PV module. Even with a symmetrical design of the module holder and central positioning of the PV module in the receptacle of the module holder, this can result in different maximum angles of incidence without shading at which sunlight can still reach the outer edge of the active surface when the PV module is inserted into the receptacle of the module holder.

Furthermore, the PV module can also have more than one active surface. The “bifacial” property can therefore be understood here in particular as meaning that the PV module has at least one active surface (i.e., two or even three active surfaces, for example), each of which can convert sunlight into an electrical current flow/voltage. If the PV module has several active surfaces, these can also differ in their respective spectral characteristics, in particular so that the respective surface converts a respective light spectrum into electrical energy. The multiple active surfaces can be laminated to one another, i.e., they are then spaced apart in a direction perpendicular to the respective plane of the active surface.

However, the approach according to the invention can preferably provide that the active surface of the PV module is arranged approximately centrally with respect to the outer dimensions of the module holder. For example, embodiments are preferred in which a lateral distance between a plane of the active surface and a center plane of the module holder is at most 10% of a total lateral extent of the module holder. In particular, the plane of the active surface and the center plane of the module holder can thus coincide.

Alternatively or, however, in addition to the features previously explained, the set mentioned at the outset can also be characterized for solving the problem in that an outer contour of the module holder (i.e., in particular the previously mentioned outer contour or, however, the previously mentioned envelope), in relation to a cross-sectional plane of the module holder running perpendicular to a plane of the active surface, lies within a shading angle spanned in the cross-sectional plane, which angle extends from an outer edge of the active surface. Furthermore it is provided that an angle bisector of the shading angle with the plane of the active surface encloses a tilt angle of at most 15°, preferably of at most 10°. The shading angle defines the shading of the active surface caused by the module holder.

For example, if the active surface lies in an xz plane (wherein the x direction may correspond to a longitudinal direction of the transoms and the z direction may correspond to the longitudinal direction of posts of an associated support structure to which the module holder is to be mounted), said cross-sectional plane may be the xy plane in the event that the module holder embraces a vertically extending transverse side of the PV module; or, for example, the yz plane in the event that the module holder embraces a horizontally extending longitudinal side of the PV module.

Limiting the tilt angle leads to a balanced distribution of the maximum shading-free angle of incidence between the front and rear of the PV module. As a result, a high efficiency of solar electricity production can be achieved with the bifacial PV module regardless of the side of the sunlight incidence. The requirement for a low tilt angle is therefore synonymous with the requirement that the active surface of the PV module should be as close as possible to a center plane of the module holder (which can be a symmetry plane in particular).

Another parameter that must be taken into account when designing the set is the offset that exists between the outer edge of the active surface and one end of the module holder on the module side when the PV module is inserted into the module holder. In principle, there is a conflict of objectives here: the greater the offset, the smaller the shading angle will be, which initially appears favorable, as this reduces the susceptibility to shading. However, a larger offset leads to a loss of active surface area and thus to lower electricity production for a given module size and given insertion depth of the module in the module holder. The maximum (glass) size of the PV module is generally limited due to the manufacturing technology. A typical current value for the cell edge distance, i.e., the distance between the outer edge of the active surface and the outer edge of the PV module, is 18-20 mm. In the future, however, smaller cell edge distances of 12-14 mm will also be possible, so that more active surface will be available for the same module size. With such a small cell edge distance, however, said offset would become smaller and smaller, which would then lead to increased shading.

In such a case, the design of the module holder according to the invention becomes more and more important, because excessive shading is thereby avoided. Therefore, the invention proposes in particular to select an insertion depth of the receptacle (in particular taking into account a minimum distance, between an outer edge of the PV module and a stop formed in the receptacle of the module holder, of 1-2 mm) such that said offset between the outer edge of the active surface and the module-side end of the module holder does not have a restrictive effect on the desired maximum angle of incidence without shading (i.e., still allows the desired respective front and rear maximum angle of incidence without shading), which will be explained in greater detail below. Here, the offset can preferably only be selected so large that the offset is at most 50%, preferably at most 20%, larger than a minimum offset that must be maintained (purely geometrically and without taking tolerances into account when inserting the PV module into the module holder) in order to ensure the desired maximum shading-free angle of incidence. This is because in this case, a compact design of the set can be obtained that optimizes the usable active surface per length/height of the associated PV system.

The shading angle described above can ideally be opened symmetrically to a center plane of the PV module (so that the center plane divides the shading angle as an angle bisector). However, depending on the specific design of the module holder and/or the lateral position of the active surface, it is also possible for the shading angle to be opened asymmetrically in relation to the center plane of the module; in this case, the tilt angle in question is therefore >0° (the tilt can be towards the front or rear). This can be the case in particular if the respective maximum shading-free angles of incidence on the active surface on the front and rear of the PV module are different.

In preferred embodiments, the shading angle is at most 100° or even at most 90°. This is because this enables particularly large maximum angles of incidence without shading. In such a configuration, 360°−100°=260°=2×130 ° (in the preferred configuration with a maximum shading angle of 90° even 270°=2×135°) remain available for the front and rear maximum shading-free angle of incidence at which sunlight can still reach the active surface when the PV module is inserted into the receptacle of the module holder.

An excessively small shading angle can result in a module holder with insufficient strength, which is particularly critical if the module holder is intended to stabilize an unstable longitudinal side of the PV module. For this reason, the shading angle should be at least 50°, preferably at least 60°. The requirement of such a minimum amount for the shading angle results in a corresponding rigidity of the module holder, as the module holder thus has a sufficient area moment of inertia in the cross-section.

In addition or alternatively to the features explained above, the set described at the outset for solving the task can also be characterized in that an outer contour of the module holder (i.e., in particular the outer contour of the module holder explained above) is designed (in particular and the associated PV module is designed and placed in the receptacle) in such a way that both a maximum angle of incidence free of shading, at which an incident sunbeam can reach an outer edge of the active surface from the front, and a maximum angle of incidence free of shading, at which an incident sunbeam can reach the outer edge of the active surface from the front, are achieved, at which an incident sunbeam can reach an outer edge of the active surface from the front, as well as a maximum shading-free angle of incidence at which an incident sunbeam can reach the outer edge of the active surface from the rear, is at least 110°, preferably at least 120°, particularly preferably at least 135°, measured in relation to the active surface.

The choice of a suitable maximum angle of incidence without shading depends largely on the geographical location of the PV module and its orientation in relation to the sun.

If the angle of incidence were not measured in relation to the plane of the active surface, but in relation to the surface normal of the active surface in a cross-sectional plane perpendicular to the plane of the active surface, this would result in a maximum shading-free angle of incidence of at least 20°(=110°−90°), preferably at least 30°(=120°−90°), particularly preferably of at least 45°(=135°−90°). It is understood that, depending on the position of the sun, i.e., the time of day, the maximum shading-free angles of incidence can be exceeded, wherein shading then occurs at the edge of the active surface, which increases non-linearly with increasing angle of incidence, which can result in a measurable loss of power of the PV module.

As already explained, it is also advantageous if the outer edge of the active surface is so far away from the module-side end of the module holder that no shading occurs on the active surface even at the maximum shading-free angles of incidence specified by the module holder on the front and rear sides. In this case, these maximum angles of incidence can actually reach the entire active surface of the PV module.

According to the invention, the problem can also be solved by further advantageous embodiments as described herein:

Thus, for example, it can be provided that the two legs of the module holder form a respective outer contour, which remains within an imaginary or actual bevel, which runs towards a module-side insertion opening of the receptacle. Here it is preferred if the respective bevel in each case forms an angle to the active surface of at least 110°, preferably of at least 120°, especially preferably of at least 135°. Here, the respective outer contour of one of the legs can deviate in places from the bevel inwards towards the receptacle.

For example, an actual bevel can be formed at the front and rear (in relation to the PV module inserted into the receptacle) on the module side (i.e., on the inside of the module holder). These bevels produce the technical effect that the described large maximum shading-free angle of incidence on the active surface is made possible and thus shading of the active surface by the module holder itself is largely avoided. In the installation situation, the respective bevel can thus, for example, prevent a steep incidence of sunlight from above (for example, if the module holder grips an upper horizontal longitudinal side of the PV module and the bevel thus points downwards) or a flat incidence of sunlight from the side (for example, if the module holder grips a vertical transverse side of the PV module and the bevel thus runs in the direction of the longitudinal side of the PV module), if the PV module is oriented in landscape format (=long side of the PV module is oriented horizontally).

A module holder according to the invention can in particular be designed symmetrically with respect to a symmetry plane of the module holder running parallel to the plane of the active surface, i.e., in particular with axially symmetrical legs. This can offer advantages because the module holder can thus be used in different orientations to grip around and protect the outer edge of the module (no difference between the front and rear of the module holder).

However, a module holder according to the invention can also be designed asymmetrically in relation to the plane of the active surface. This is particularly suitable if the active surface within the PV module is offset from a center plane of the PV module. In this case, a symmetrical design of the module holder would result in asymmetrical maximum angles of incidence without shading for the front and rear of the PV module. An asymmetrical design of the module holder (e.g. by forming different bevels on the front and rear and/or by varying the lateral extent of the front or rear leg) can therefore be used to ensure that the sun's rays can reach the active surface from both the front and the rear at the same maximum angle of incidence, for example at least 110° in each case. However, an asymmetrical design of the module holder can also be useful if the maximum possible angle of incidence without shading is to be designed asymmetrically due to the low bifaciality of the PV module (rear side power of the active surface differs greatly in relation to the power of the front side).

The two legs of the module holder can each have a lateral extent, transverse to a center plane of the PV module and each measured from the receptacle, which is at least 25 %, preferably at least 50 %, particularly preferably at least 75 %, of a minimum width of the receptacle, in the direction of a surface normal of the active surface. Depending on the design, a width of the receptacle can increase in the insertion direction. This allows sufficient mechanical strength to be achieved while at the same time minimizing shading on the front and rear of the PV module.

The center plane of the PV module can under circumstances be laterally offset from a center plane of the receptacle or to a center plane or symmetry plane of the module holder; this depends on the structure of the PV module used.

If, for example, the PV module has a format (longitudinal side/transverse side) of approximately or even greater than 2:1, it is advisable to stabilize the longer longitudinal side of the PV module using a module holder according to the invention, the legs of which each have a lateral extent of more than 0.75 times the minimum width of the receptacle (which can correspond at least to the thickness of the PV module). Module holders designed in accordance with the invention can then also be used to stabilize the transverse sides; however, the lateral extent of the legs may be smaller there under certain circumstances because fewer forces act on the transverse side and the module holder can therefore be designed to be somewhat less stable there.

The respective tips of the front and rear legs can be spaced either equally or differently from the outer edge of the active surface, viewed in a cross-sectional plane (xy or yz plane) perpendicular to a plane of the active surface. For optimum surface utilization, at least one of the tips of the front or rear leg can reach up to the active surface. However, overlapping of the active surface by the module holder should be avoided in any case in order to prevent power losses due to shading.

A module holder according to the invention can have an overall extent transverse to a center plane of the photovoltaic module that is at most 5 times, preferably at most 4.5 times, a minimum width of the receptacle. This applies in particular to thicknesses of the PV module of more than 5 mm. If, on the other hand, the thickness of the PV module is less than 4 mm, the total extent can be higher, but should then be at most 8 times the minimum width of the receptacle, for example. Such designs result in a comparatively narrow lateral extent of the module holder and thus in reduced shading.

A particularly preferred embodiment provides that the two legs of the module holder are designed as part of a hollow profile. Preferably, the entire module holder can be formed here by the hollow profile. The hollow profile can preferably be designed, at least in portions, as a longitudinal profile with a constant cross-section.

It is furthermore preferable if the two legs are connected to each other mechanically via a closed (in particular annular) hollow chamber wall of the hollow profile. This or another closed hollow chamber wall of the hollow profile can form a hollow chamber (designated 32c in the figures). By means of such embodiments, the mechanical strength of the module holder can be increased, without this having negative effects on the shading: This is because it may preferably be provided that said hollow chamber, which is delimited by a closed hollow chamber wall of the hollow profile, is arranged in the module plane. In other words, the plane in which the active surface of the PV module, which is held by the hollow profile/module holder, runs through said hollow chamber. Preferably, a geometric center of gravity of the hollow chamber can have a lateral distance transverse to the module plane which is less than 25% of a lateral extent of the hollow chamber transverse to the module plane (in each case with reference to a cross-section through the hollow chamber which runs perpendicular to the module plane—cf. for example FIG. 3). Very preferably, this center of gravity can even lie in the module plane.

An arrangement of the hollow chamber in the module plane as described above is at first glance bad in terms of the effective module surface, as this increases the gross size of the module while the net area of the active surface remains the same. However, the invention has recognized that there is a certain trade-off here between mechanical stability on the one hand and shading of the active surface on the other. The arrangement according to the invention thus enables low shading on the one hand and sufficient stability of the module holder on the other, especially when the set is designed in the form of a framed PV module.

A particularly preferred embodiment can therefore provide that the closed hollow chamber wall forms a hollow chamber that in the insertion direction follows the receptacle (i.e., is arranged behind it, preferably in the module plane).

In addition or alternatively (i.e., for example if the hollow chamber wall cannot or should not be completely closed or said hollow chamber cannot be arranged in the module plane), it can be provided according to the invention, in order to increase the mechanical stability of the module holder, that the hollow profile has a wall thickness thickening in the region of the receptacle, which thickening lies in the module plane. This can effectively prevent a potentially mechanically weak buckling point from occurring in this area, in particular if triangular hollow chambers will be/are formed in the hollow profile to define the two legs.

The module holder may further have, at its module-side end, a cross-sectional width transverse to the insertion direction, which corresponds at most to the sum of the minimum width of the receptacle and twice a material thickness of the hollow profile. In this case, only one material thickness of the hollow profile is connected to the front and rear of the receptacle at the module-side tip of the module holder. Such a design ensures excellent mechanical strength, particularly in the direction of the respective longitudinal or transverse side of the module, which is to be stabilized by the module holder, while at the same time using less material and thus reducing costs. At the same time, the tapered cross-section at the end of the module holder on the module side also minimizes the shading effect.

In order to increase the strength of the module holder, a particularly preferred embodiment provides that the front and rear legs, which delimit the receptacle, are each formed by means of a closed hollow chamber wall (which can preferably have a triangular cross-section) of the hollow profile. In this way, each of the two legs can form a respective hollow chamber, which, in relation to the insertion direction, are arranged to the left and right of the receptacle. In relation to the active surface, these two hollow chambers are therefore located in front of or behind the receptacle or the PV module inserted into the receptacle.

A module holder according to the invention can for example be designed as a (in particular single) module holding element. Thus, the module holder can merely embrace a partial portion of the circumferential outer edge of the associated PV module or support it at least on one side. Here it is preferred if the set comprises several such module holding elements or module holders, which in each case embrace partial portions of the outer edge, thus in particular partial portions of a respective longitudinal side or transverse side of the PV module, or support them on at least one side.

In an alternative embodiment is provided that the set comprises at least four module holders, which together form a module frame, preferably rectangular, surrounding the PV module. The module frame can thus be closed within itself. For this purpose, the module holders can be joined together at several joining points to form the module frame. The joining of several module holders to form the module frame can be realized by means of conventional corner connectors. These corner connectors can be inserted into the respective profile of two module holders in order to connect these two module holders together.

Also possible are embodiments of the module frame in which a respective spacing between tips of the legs of the respective module holder (which stabilizes the PV module on the transverse or longitudinal side) and the outer edge of the active surface in relation to the front side and/or in relation to the rear side are selected to be of different sizes. However, the respective spacing can also be the same, especially if the cross-section of the module frame is approximately symmetrical. A preferred embodiment provides however for, that a spacing of a tip of an upper module holder, which is arranged on an upper side of the PV module, is selected to be larger than a spacing of a tip of a lower module holder, which is arranged at of an underside of the PV module, namely in each case in relation to the active surface of the PV module. Such configurations can optimize the use of space, whereby, in relation to a certain length or height of the support structure of a PV system in which the set is installed several times, more active surface can be arranged overall.

A module frame of this type can, for example, have a cross-sectional shape on the front and rear side in the form of a bevel cut passe-partout, similar to a picture frame, in relation to a center plane of the module frame running parallel to the active surface of the PV module. The inclined surfaces allow the desired large angles of incidence.

At this point, it is important to note that not all of the four module holders must be designed with a convex profile according to the invention. For example, a greater distance to the active surface on a lower module holder may be dispensable because in the final mounting position the sun's rays always fall on the vertically aligned active surface of the PV module from above, but never from below (therefore the lower module holder mentioned can reach right up to the active surface). For the same reason, it is even possible to dispense with the formation of a bevel on and/or a convex shape of the lower module holder. However, for reasons of more efficient production, embodiments are preferred in which at least the two vertically extending left and right module holders of the module frame are formed with the same cross-sectional profile as one another and also the upper and lower module holders of the module frame are also formed with the same cross-sectional profile as one another.

A design in which all four module holders of the module frame have an identical cross-sectional profile is particularly preferred. This simplifies joining at the joints.

It may also be provided that the module frame has a first cross-section along a longitudinal side of the photovoltaic module and a second cross-section along a transverse side of the PV module. In this case, the second cross-section, which stabilizes the transverse side of the PV module, can offer greater mechanical rigidity and/or be larger, in particular wider, than the first cross-section, which stabilizes the longitudinal side of the PV module. In this way, a minimum use of material can be achieved with sufficient stabilization of the PV module.

Various designs are possible for holding the edge of the PV module in the receptacle. For example, the edge can be clamped and/or glued in place, which can be done in particular with the aid of an adhesive tape. According to a preferred embodiment, the edge of the PV module is glued into the receptacle sealingly using a sealing compound. Liquid silicone adhesives are particularly suitable as a sealing compound or sealing adhesive. These can harden in the receptacle and thus fill any remaining gaps between the PV module and the module holder. When using adhesive tapes, it is advisable to design the receptacle in a V-shape so that the width of the receptacle decreases in the insertion direction.

Generally it is advantageous for the shading if a tip of the front leg and/or of the rear leg forms or defines the module-side end of the module holder. This feature distinguishes embodiments according to the invention from previously known module frames, in which a stabilizing leg arranged laterally to the receptacle is formed, which still protrudes on the module side beyond the receptacle.

For solving the mentioned problem, one or more of the features disclosed herein directed to a PV system are furthermore provided according to the invention. In particular it is thus proposed in accordance with the invention for solving the task in a PV system of the type described at the outset that the PV modules are each fixed by means of at least one respective module holder, preferably by means of at least two module holders, to the support structure. Furthermore it is provided that the respective bifacial PV module and the associated at least one module holder each form a set, as has previously been described or as disclosed herein directed to a set according to the invention.

In each case, two posts and two transoms of the support structure can define a substantially rectangular mounting field in which at least one of the PV modules is arranged. The posts and also the transoms can preferably be designed in the form of metal longitudinal profiles. These longitudinal profiles can be produced very simply by cold forming, i.e., as so-called cold profiles. The module holder, on the other hand, can be manufactured using continuous aluminum casting.

The posts of the support structure can be set up in a row, for example, to create a solar fence. In order to realize a large-scale PV system, the posts can also be set up in rows spaced apart from each other. In this case, the posts in a row can substantially form a plane.

A free space can be kept free between the ground and one of the lowest transoms of the support structure in order to enable agricultural cultivation of this free space between the posts. Similarly, a free space formed between the rows of posts mentioned above can be used for agricultural purposes.

Common PV modules typically have a rectangular basic shape, for example with an aspect ratio of approximately 2:1. In a PV system according to the invention, such PV modules can be mounted on the support structure in both landscape and portrait format.

According to one possible embodiment, the module holders can be inserted, preferably non-rotatably, into a respective receptacle formed by one of the transoms or posts.

It is therefore proposed in particular to use a set of a module holder and an associated bifacial PV module, as described above or herein, to be attached to a support structure in order to form a powerful and extremely (wind) stable PV system. The PV system can be assembled in such a way that the support structure, i.e., the posts and the associated transoms, are mounted first, wherein substantially rectangular mounting fields are formed between the posts. Subsequently, one or more sets according to the invention can be attached in the mounting field, i.e., to the support structure, in order to complete the PV system.

The respective set, which is formed by a PV module and the associated at least one module holder, can for example comprise a module holder that is fastened to one of the posts, which can preferably be realized by means of separate fastening elements. It may also be additionally or alternatively provided that the respective set comprises a module holder which is fastened below one of the transoms, preferably by means of separate fastening elements. These module holders attached to the posts and/or transoms are then designed with features according to the invention (as described above).

The mechanical connection of the respective PV module to the transoms and/or posts of the support structure can thus be realized exclusively via (separate) module holders. However, not all of these module holders need to be designed with a convex profile according to the invention; this applies in particular to module holders that grip around a horizontal underside of the PV module, as no shading of the active surface occurs there when sun rays fall in from above. Therefore, these lower module holders do not necessarily have to have bevels, for example.

A PV system according to the invention can thus comprise a support structure with transoms, on the underside of which a module holder of one of the aforementioned sets is suspended, preferably by means of separate fastening elements. Furthermore, the support structure can have transoms to the upper side of which a module holder of one of the aforementioned sets is attached, preferably by means of separate fastening elements. In both cases, a cross-section of the respective transom, which runs transversely to a longitudinal direction of the transom, can be selected such that a respective maximum angle of incidence without shading, at which a respective incident sunbeam can reach the active surface of the PV module from the front or from the rear, is determined by an outer contour of the module holder (and not, for example, by an outer contour of the transom used). In other words, in such an embodiment, the respective angle of incidence is restricted by the transom at most as much as it is already restricted by the module holder. To make this possible, the transom can have or form a respective bevel on its underside, at the front and rear and in relation to the photovoltaic module.

In the final mounting position, the cross-section of the transom can thus lie in particular within a shading angle that is spanned in the cross-sectional plane, which starts from an outer edge of the active surface of the PV module of the set and which is at most 100°, preferably at most 90°. This effectively prevents the transom from causing shading of the active surface of the PV module located under the transom.

A preferred embodiment of the PV system is that those transoms on the underside (or top side) of which one of the sets is mounted are designed with a longitudinal profile that is semi-open at the top (or bottom). Such a semi-open longitudinal profile can preferably be designed in the form of a C-profile.

Furthermore, it may be provided that individual fastening elements mentioned above are inserted into, preferably slot-shaped, through-holes on the underside (or top side) of transoms. This allows a module holder of one of the sets arranged below (or above) the transom to be attached to the transom.

In a further embodiment, the fastening elements mentioned form respective tabs on the front and rear, to which the module holder of the associated set is mounted, i.e., preferably clamped or screwed.

The support structure can, for example, also include transoms that are designed with a longitudinal profile that is half-open at the bottom (these can of course be the same profiles, just used in a different orientation). Module holders can then be mounted above such transoms in a similar way.

The fastening elements can also form front and rear support legs (in relation to the module level), which are supported on the inside of the transom in the mounting position. This allows retaining forces to be transferred to the transom. For example, such support legs can be designed as bent-up tabs that lie flat against the inside of the aforementioned semi-open longitudinal profile. For their part, the fastening elements can be screwed to the transom, whereby this screw connection can be formed in the area of the contact legs. As a result, a contact surface of the respective contact leg can be pressed against the inside of the transom by means of the screw connection.

### BRIEF DESCRIPTION OF THE DRAWINGS

The invention is now described in greater detail on the basis of exemplary embodiments, but is not limited to these exemplary embodiments. Further embodiments of the invention can be obtained from the following description of a preferred exemplary embodiment in conjunction with the general description, the claims and the drawings. The drawings are to be understood schematically and not necessarily, but only approximately to scale.

In the following description of various embodiments of the invention, elements that match in their function are provided with matching reference numerals even with differing design or shaping.

In the drawings:

FIG. 1 shows a previously known module holder in the form of a module frame with a stabilizing leg on the rear side,

FIG. 2 shows another previously known module holder in the form of a module frame, which is slightly narrower than the one in FIG. 1,

FIG. 3 shows a cross-section of a first module holder designed according to the invention with the associated PV module inserted,

FIG. 4 shows a cross-section of a second module holder designed according to the invention with the associated PV module inserted,

FIG. 5 shows the same module holder as in FIG. 4, but with a different type of PV module,

FIG. 6 shows details of the cross-section of a hollow profile that forms the module holder in FIGS. 4 and 5,

FIG. 7 shows a side view (in y-direction) of a first PV system according to the invention,

FIG. 8 shows a side view (in y-direction) of a second PV system according to the invention,

FIG. 9 shows a side view (in y-direction) of a third PV system according to the invention,

FIG. 10 shows a cross-section of a (schematically shown) transom of a PV system, on the underside of which a module holder is mounted,

FIG. 11 shows a set designed according to the invention formed of a module holder and an associated PV module, wherein here the active surface 9, which specifies a module plane, lies in a center plane of the PV module,

FIG. 12 shows the influence of the offset between the module-side end of a module holder according to the invention and the active surface of a PV module inserted in it,

FIG. 13 shows a set according to the invention, wherein the active surface of the PV module is offset towards the rear side in relation to a symmetry plane of the associated module holder,

FIG. 14 shows a set according to the invention, wherein the active surface of the PV module, in relation to a center plane of the associated asymmetrically designed module holder, is offset from the front side,

FIG. 15 shows a set according to the invention, wherein the active surface of the PV module is arranged in a center plane of the PV module and the module holder is designed asymmetrically,

FIG. 16 shows a cross-section of a transom of a PV system (shown schematically), on the underside of which a set according to the invention is mounted,

FIG. 17 shows a view from above of a transom of a PV system according to the invention, and finally

FIG. 18 shows an oblique view from the side of the transom from FIG. 17 with the PV module and associated module frame mounted underneath.

### DETAILED DESCRIPTION

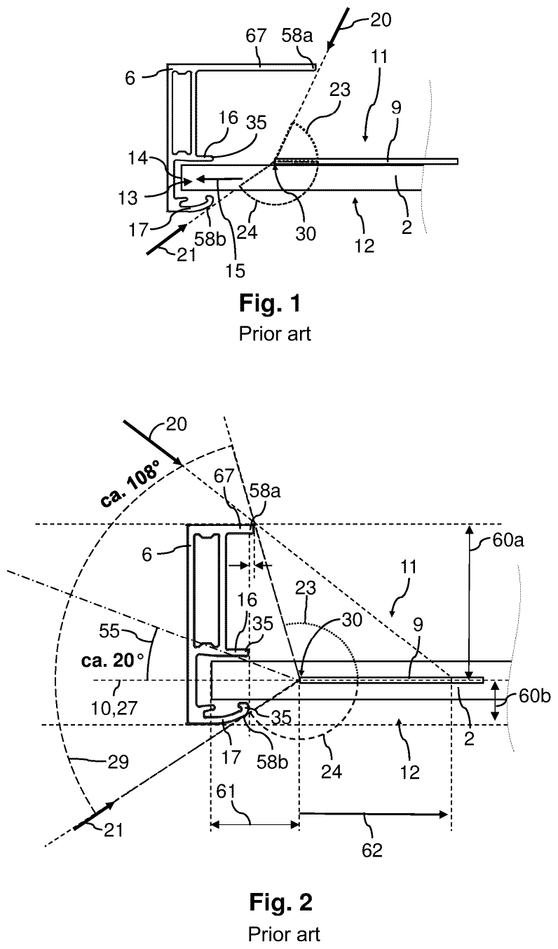

FIG. 1 shows a module holder 6 known from the prior art in the form of a module frame with a stabilizing leg 67 at the rear. The module holder 6 provides a receptacle 13 into which an outer edge 14 of an associated photovoltaic module 2 in the form of a glass laminate is inserted in an insertion direction 15 and thus held in position. The PV module 2 has an active surface 9 on the rear side, which can receive sunlight both from the front side 12 and from the rear side 11 of the PV module 2 in order to convert the sunlight into electrical current.

As can be seen in FIG. 1, the receptacle 13 is limited at the front by a front leg 17 and at the rear by a rear leg 16 of the module holder 6. It is true that the sun ray 21 incident on the PV module 2 can reach the outer edge 30 of the active surface 9 at a comparatively large maximum angle of incidence 24 without shading at the front. At the rear, however, said stabilizing leg 67 protrudes very far beyond the front and rear legs 17, 16, so that the outermost point 58a of the stabilizing leg 67, which is relevant for the rear shading of the active surface 9, protrudes beyond the receptacle 13 in the opposite direction to the insertion direction 15. This is disadvantageous in that the sun ray 20, which falls on the rear side 11 of the PV module 2, can only reach the outer edge 30 of the active surface 9 at a comparatively small angle of incidence 23.

FIG. 2 shows a further example of a previously known module holder 6 with inserted PV module 2. Compared to the example in FIG. 1, the active surface 9 is now located inside the PV module 2. In addition, the stabilizing leg 67 in question is considerably shorter than in the embodiment shown in FIG. 1, which results in a lower stability of the module holder 6, but already considerably reduces the shading angle 29 (in relation to the outer edge 30 of the active surface 9) spanned by the module holder 6 (cf. FIG. 1).

However, the design of the module holder 6 according to FIG. 2 is also suboptimal for use with a bifacial PV module 2, since the module holder 6 has a considerable lateral distance 60a on the rear side from the plane 10 of the active surface 9 of the PV module 2, which is often also referred to as the module plane. Therefore, if a sun ray 20 falls on the rear side of the PV module 2 at an angle which-as shown in FIG. 2—exceeds the maximum angle of incidence 23 without shading, the module holder 6, or more precisely its rear stabilizing leg 67, in particular the outer point 58a shown, shades the active surface 9. Since the lateral distance 60a is comparatively large, a considerable shading length 62 (this depends linearly on 60a) occurs even if the maximum shading-free angle of incidence 23 is exceeded slightly. At such a solar incidence, the entire edge area of the active surface 9, which corresponds to the shading length 62, can therefore no longer receive sunlight and therefore no longer contribute to electricity production.

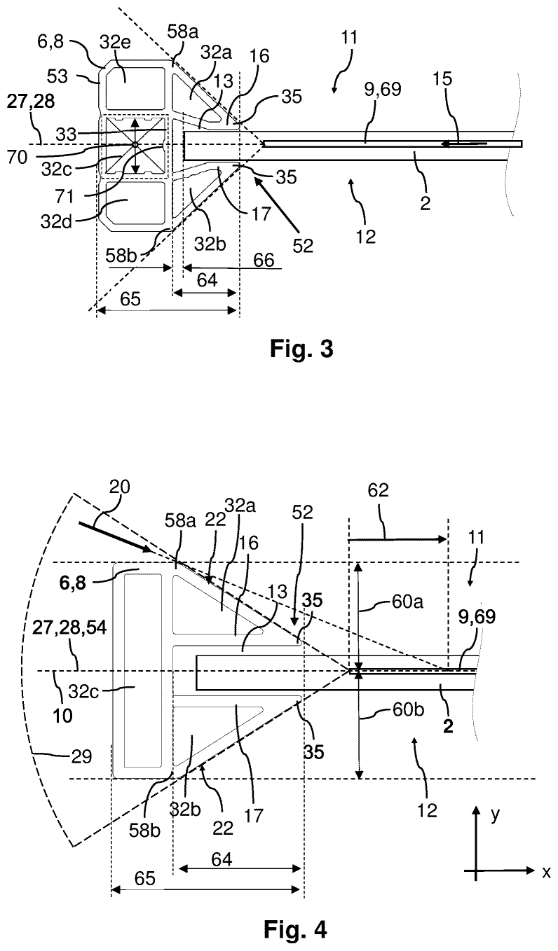

FIG. 3 shows a first example of a set according to the invention consisting of a module holder 6 and an associated bifacial PV module 2. Also here the module holder 6 again forms a receptacle 13, which is delimited on the front side by a front leg 17 and on the rear side by a rear leg 16. However, it can be seen at first glance that the module-side tips 35 of the two legs 16 and 17 form the module-side end 52 of the module holder 6. The respective outer points 58a, 58b (of the cross-section of the module holder 6 extending perpendicularly to the plane 10 of the active surface 9), which are relevant for the shading of the active surface 9 by the module holder 6 at the front and rear respectively, are thus recognizably offset in the insertion direction 15 and in relation to the two aforementioned tips 35 of the two legs 16, 17. The axial offset of these outer points 58 a, 58 b to the respective tip 35 is more than 1.5 times the minimum width of the receptacle 13. The decisive factor here is that the outer points 58a, 58b relevant for the shading are set back in such a way that the active surface 9 remains free of shading. The profile 8 could, for example, also be open at the top, i.e., the hollow chamber 32e does not necessarily have to be closed in cross-section; however, this is advantageous for a higher mechanical stability of the hollow profile 8/module holder 6.

Another striking feature of the hollow profile 8 shown in FIG. 3 (as well as that of FIG. 4) is the specific arrangement of the hollow chamber 32c, which in the example shown is delimited by a wall of the hollow profile 8 that is closed in cross-section. This hollow chamber 32c, preferably its geometric center of gravity as shown, is located in the module plane 69, i.e., in the plane in which the active surfaces 9 of the PV modules 2 are located. In addition, the hollow chamber 32c extends both beyond the front side 12 of the PV module 2 and beyond its rear side 11. It can even be seen in FIG. 3 that the geometric center of gravity 70 of the hollow chamber 32c lies in the module plane 69. Such arrangements and designs of the hollow chamber 32c make it possible to increase the mechanical stability of the hollow profile 8 without having to accept losses in terms of freedom from shading, as was often the case with previously known mountings, where such a chamber was arranged in front of or behind the module plane. In the example shown, the center of gravity 70 is therefore in the middle in relation to the lateral extent of the hollow chamber 32c transverse to the module plane 69 (cf. the double arrow).

FIG. 3 also shows that to further increase the mechanical stability of the module holder 6, the hollow profile 8 has a wall thickness thickening 71 in the region of the receptacle 13. This wall thickness thickening 71 is located in the module plane 69 and is formed on a wall of the hollow profile 8, which connects the two legs 16 and 17 or the two hollow chambers 32a and 32b. In addition, this wall limits the receptacle 13, so that a high mechanical strength of the module holder 6 can be maintained despite the low shading angle.

FIG. 4 shows a further example of a set according to the invention comprising a module holder 6 and an associated PV module. Also in this example the axial offset of the two outer points 58a and 58b in comparison to respective tip 35 of the associated leg 16, 17 can be clearly recognized. Furthermore, in both examples of FIGS. 3 and 4, it can be seen that the respective module holder 6 is designed to be axially symmetrical in relation to a center plane 27 of the PV module 2, which thus forms the plane of symmetry 28 of the respective module holder 6. Due to this axial symmetry-with comparable mechanical strength-the respective lateral distances 60a and 60b between the module plane 10 and the outermost edge of the module holder 6, as can be seen in FIG. 3 and FIG. 4, can each be designed to be significantly smaller than the dimension 60a in the example of FIG. 2. Accordingly, it can also already be seen in FIG. 4 that the shading length 62 is correspondingly smaller when the maximum front or rear shading-free angle of incidence 23, 24 is exceeded.

In comparison to the previously known example of FIG. 1 it is additionally striking in the inventive embodiments of FIGS. 3 and 4 that both front and also rear large maximum shading-free angles of incidence 23, 24 of at least 135° in each case are made possible.

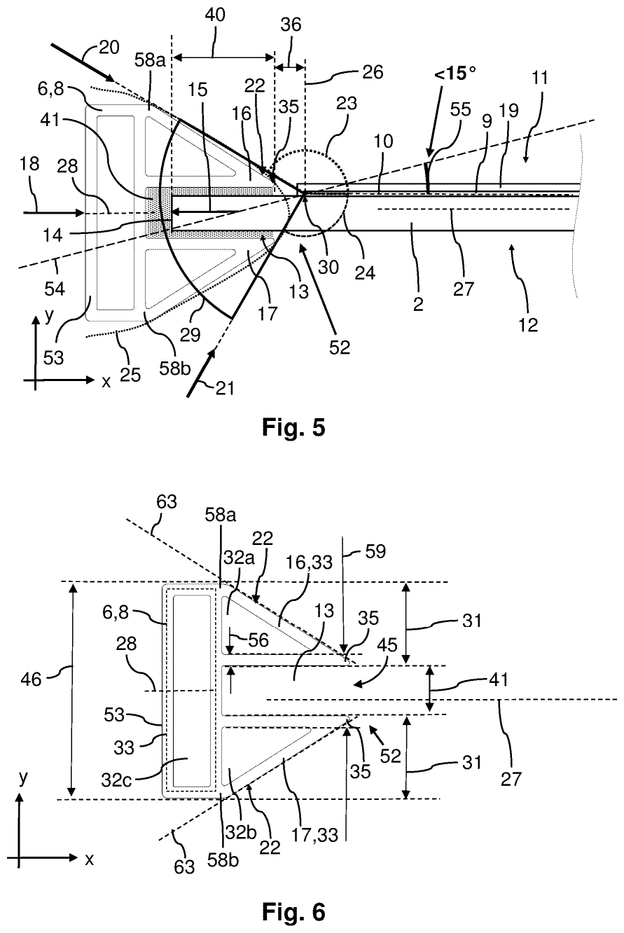

FIG. 5 explains the concept according to the invention again using the same module holder 6, which has already been shown in FIG. 4 and the geometric details of which are illustrated in FIG. 6. However, shown in FIG. 5 is the case that a PV module 2 is inserted, in which the active surface 9 is laterally offset with respect to a center plane 27 of the PV module 2. Although the PV module 2 is inserted centrally in the receptacle 13 of the module holder 6 and although the module holder 6 is still axially symmetrical to its plane of symmetry 28, on the rear side 11 a maximum shading-free angle of incidence 23 thus results, which is a few degrees greater than the associated maximum shading-free angle of incidence 24 on the front side 12, as can be seen in FIG. 5.

Also in FIG. 5 a shading angle 29 can be identified, which starts from the outer edge 30 the active surface 9 of the PV module 2 and runs in the cross-sectional plane (xy-plane in FIG. 5) of the module holder 6, which in turn is perpendicular to the plane 10 (xz plane in FIG. 5) of the active surface 9. As can be seen in FIG. 5, an outer contour 22 of the module holder 6 lies within this shading angle 29. Also the module-side end 52 lies within the shading angle 29. It can also be seen that the angle bisector 54 of the shading angle 29 with the plane 10 of the active surface 9 encloses a tilt angle 55 that is less than 15°. Due to this configuration of the set consisting of the module holder 6 and the inserted PV module 2, the shading-free angular areas are distributed more or less evenly between the front side 12 and the rear side 11 of the PV module 2. Since the shading angle 29 is also less than 90°, it is ensured that in the case shown in FIG. 5, the maximum shading-free front angle of incidence 24 and the maximum shading-free rear angle of incidence 23 are in each case at least 120°.

In order to achieve such high values for the maximum shading-free angles of incidence 23, 24, it is crucial that the envelope 25 of the module holder 6 illustrated as a dotted line in FIG. 5, which thus envelops the outer contour 22, has a convex shape when viewed in the insertion direction 15. This is because, as can be seen in FIG. 5 and in particular as is illustrated again in greater detail in FIG. 6, the respective front and rear outer contour 22 of the xy cross-section of the module holder 6, which is formed in particular by the two legs 16 and 17, remains within the illustrated bevel 63, which in each case runs towards the module-side insertion opening 45 of the receptacle 13. In the example shown in FIG. 6, the two bevels 63 each form an angle of more than 145° to the active surface 9. Of course, it would not be critical for the shading if the outer contour 22 were to deviate inwards from the bevel 63 at some points (i.e., in the direction of the plane 10 of the active surface 9).

In FIG. 5 it can also be seen that the edge 14 of the PV module 2 is glued sealingly in the receptacle 13 by means of a sealing compound 41.

On the basis of the FIG. 6 it can be well recognized that the two legs 16, 17 of the module holder 6 each have a lateral extent 31, transverse to a center plane 27 of the PV module 2 (not shown in in FIG. 6) and in each case measured from the receptacle 13, which accounts for more than 75% of the shown minimum width 41 of the receptacle 13. Here it is initially irrelevant whether the center plane 27 of the PV module 2 is laterally offset from a center plane of the receptacle 13 or approximately to the symmetry plane 28 of the module holder 6 shown in FIG. 6. Advantageously with such a large respective front and also rear lateral extent 31, the module holder 6 can provide considerable rigidity, but at the same time also sufficient freedom from shading can be ensured.

FIGS. 3 to 6 also show that the module holder 6 is formed by a hollow profile 8, which in turn is designed as a longitudinal profile with a constant cross-section. In both the design shown in FIG. 3 and that shown in FIGS. 4 to 6, a closed hollow chamber wall 33 is provided, which is illustrated with a dashed line in FIGS. 3 and 6. This closed hollow chamber wall 33 mechanically connects the two legs 16, 17 to each other and thus ensures excellent stability of the module holder 6.

Particularly in FIG. 6 it can also be well recognized that both the front and rear legs 17, 16 are also each formed with the aid of a self-contained hollow chamber wall 33 of the hollow profile 8. These hollow chamber walls 33 have a triangular cross-section. It can also be seen that in FIG. 6 the module holder 6 has a cross-sectional width 59 at its module-side end 52 transverse to the insertion direction 15, which corresponds to the sum of the minimum width 41 of the receptacle 13 and twice the material thickness 56 of the hollow profile 8. Such a configuration is particularly advantageous because it allows the module-side end 52 to approach the outer edge 30 of the active surface 9 of the PV module 2 with very little offset 57 (see FIG. 12). As a result, a compact design can be obtained that minimizes the space required for the set per active surface 9 of the PV module 2.

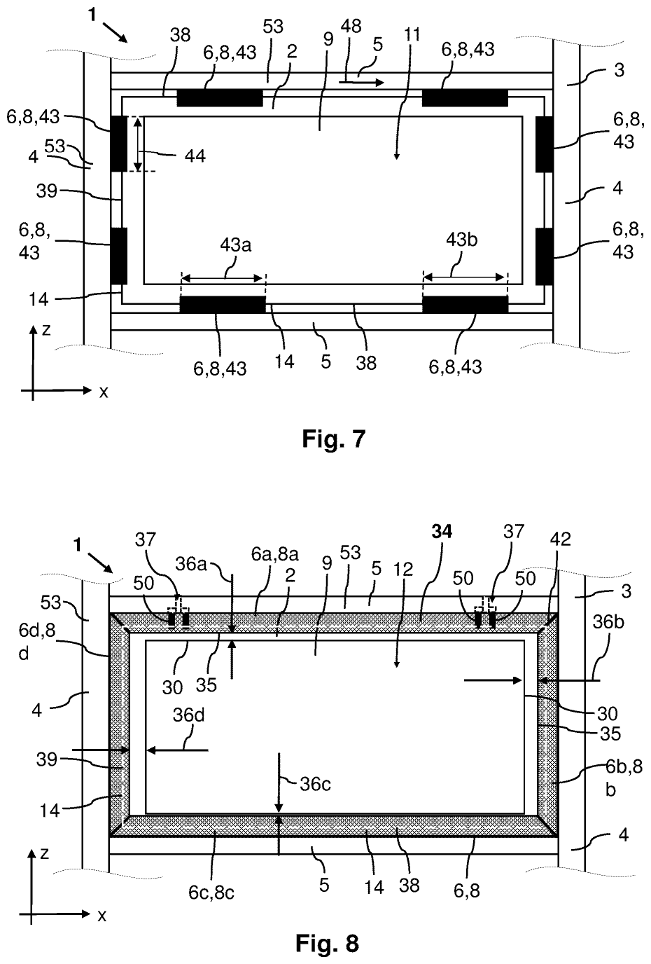

FIG. 7 shows a first example of how a photovoltaic system 1 can be realized using a set according to the invention, in which several bifacial PV modules 2 are fixed upright to a support structure 3. The support structure 3 comprises several posts 4 that run vertically in the z-direction and are fixed to the ground. Horizontal transoms 5 are attached to the posts 4, thus connecting two neighboring posts 4 to each other. As can be clearly seen in FIG. 7, this defines substantially rectangular mounting fields in which at least one PV module 2 can be arranged; in the example in FIG. 7, for example, only a single PV module 2 is suspended in a ‘landscape’ orientation in the mounting field, so that the long side 38 of the PV module 2 runs horizontally along the transoms 5. In other embodiments, however, several PV modules can also be mounted on top of each other and/or next to each other within the mounting field.

As can be seen in FIG. 7, the module holder 6 of the set is designed in the form of several module holding elements 43, wherein each of these module holding elements 43 embraces only a partial portion 44 of the circumferential outer edge 14 of the PV module 2. The module retaining elements 43 provide either a mechanical connection between one of the transoms 5 and the PV module 2 or between the PV module 2 and one of the posts 4. The upper and lower module retaining elements 43 in particular, which hold the PV module 2 on the horizontally extending longitudinal sides 38 of the PV module 2, must have considerable mechanical strength in order to safely dissipate the wind loads acting on the surface of the PV module 2 into the respective transom 5. In addition to this, for example, a direct mechanical connection of two PV modules 2 arranged one above the other or next to each other can also be realized via such a module holding element 43; in this case, the corresponding module holding element 43 thus provides a respective receptacle 13 on both sides, into which the edge 14 of the respective PV module 2 is inserted.

FIG. 8 shows a further PV system 1 according to the invention, wherein here the set comprises at least four module holders 6a, 6b, 6c, 6d, which together form a rectangular module frame 34, which runs around the PV module 2. Here, the total of four module holders 6 are joined together at several joints 42 by means of corner connectors to form the module frame 34.

In contrast to in the example of FIG. 7, in FIG. 8 it can be seen that there the spacing 36a of the tip 35 of the upper module holder 6a, which is arranged on the upper side of the PV module 2, is selected to be greater than the spacing 36c of the tip 35 the lower module holder 6c, which is arranged on the underside of the PV module 2, specifically in each case in relation to the active surface 9. Since the sun's rays always come in from above, the lower module holder 6c can move very close to the outer edge 30 of the active surface 9 without fear of relevant shading. Such a design can reduce the overall height of the PV system 1, which is favorable for absorbing wind loads, especially if several PV modules 2 are arranged one above the other.

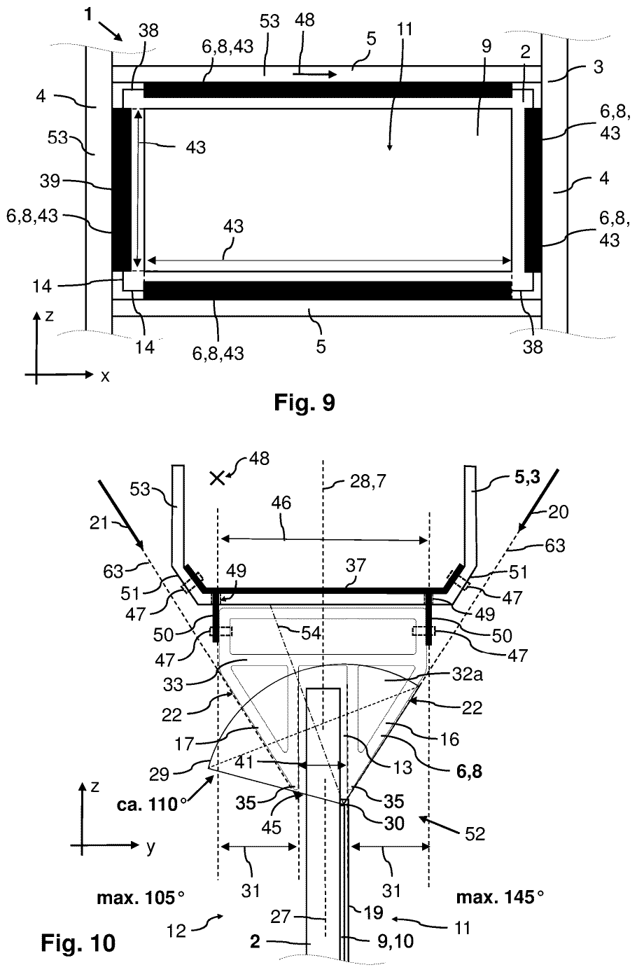

FIG. 9 shows a further possible embodiment of the set according to the invention: Here, a total of four module holders 6 are also provided in the form of separate module holding elements 43, which, however, unlike in the example of FIG. 8, are not joined together to form a circumferential module frame 43.

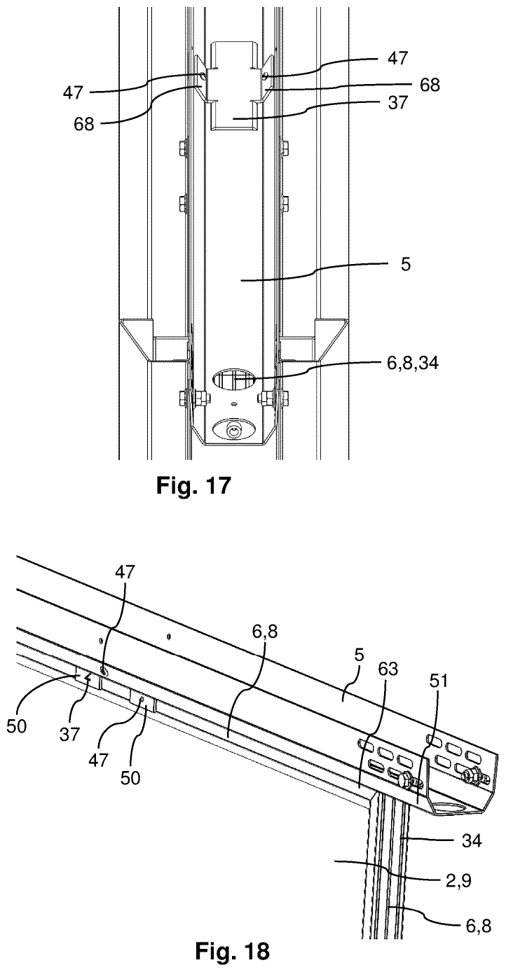

FIG. 10 shows how, for example, the upper module holder 6 in FIG. 9 (or the module holder 6a of FIG. 8), which embraces the upper longitudinal side 38 of the PV module 2, can be connected to the transom 5 above it. For this purpose, separate fastening elements 37 are provided, which are inserted into slot-shaped through-openings 49 on the underside of the transom 5 shown in FIG. 10 (see also FIG. 17), in order to fasten the module holder 6 arranged below the transom 5 to the transom 5. Here, the fastening element 37 shown in FIG. 10 forms a respective tab 50 both on the front side 12 and on the rear side 11 (cf. also FIG. 18), to which the module holder 6 is fastened.

In FIG. 10 the module holder 6 is designed analogously to the example of FIG. 6 with a respective front and rear bevel 63, whereby in principle, as illustrated in FIG. 4, a shading angle of less than 90° can be achieved, so that both on the front and also rear side at least a maximum shading-free angle of incidence of 110° should be achievable. However, a suitable PV module 2 must be selected for this, wherein the lateral position of the active surface 9 is particularly important, as well as the offset 57 that exists between the module-side end 52 of the module holder 6 and the outer edge 30 of the active surface 9 (see FIG. 12). This offset 57 depends on the one hand on the so-called cell edge distance 61, i.e., the distance between the outer edge of the PV module 2 and the outer edge 30 of the active surface 9 (cf. FIG. 2 or FIG. 12) and on the other hand on the insertion depth of the PV module 2 into the receptacle 13 of the module holder 6 (the distance 66 between the outer edge 14 of the PV module 2 and a stop formed by the module holder 6 in the receptacle 13 can vary—cf. FIG. 3). In the example shown in FIG. 10, however, both the lateral offset of the active surface 9 to the center plane 27 of the PV module 2 and the offset 57 between the outer edge 30 of the active surface 9 and the module-side end 52 of the module holder 6 are so unfavorably selected that a shading angle of approximately 110° and also a strong tilt of the shading angle 29 towards the front side 12 (note the angle bisector 54 in FIG. 10, which has a tilt angle 55 of more than 20° in relation to the plane 10 of the active surface 9). Therefore, only a maximum shading-free angle of incidence on the active surface 9 of 105° can be achieved on the front side, which would lead to a loss of power.

However, as FIG. 16 shows, by using a PV module 2 with a centrally positioned active surface 9, the situation can be improved to such an extent that the shading angle is now only 65° and maximum shading-free angles of incidence of more than 145° can be achieved on both the front and rear.

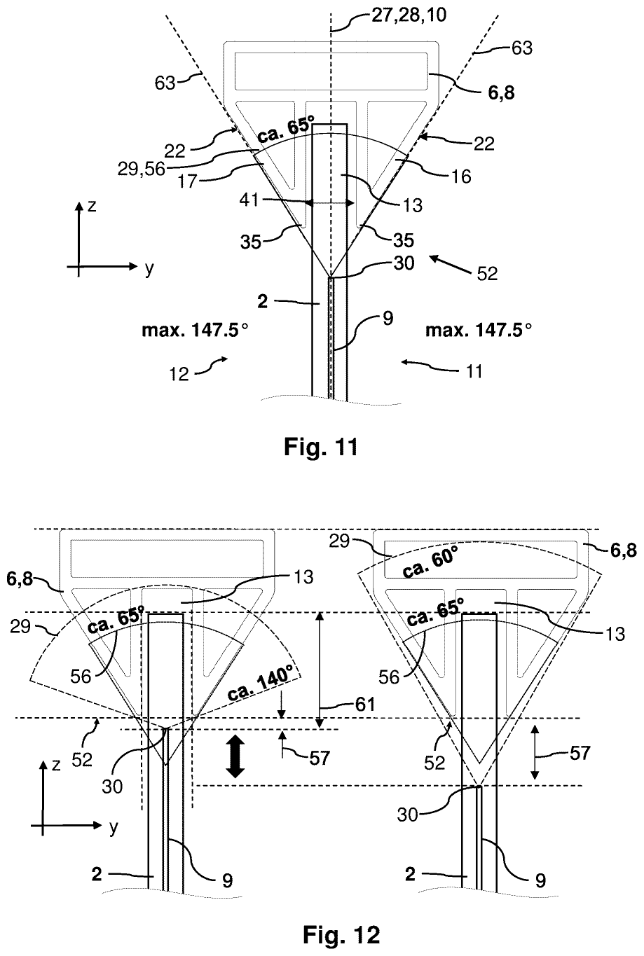

This situation is also again shown in detail in FIG. 11: It can be seen there that the front and rear bevel 63 of the module holder 6, which are each symmetrical with respect to the symmetry plane 28 of the module holder 6 shown, span an opening angle 56 of approximately 65°. If, as in FIG. 11, a PV module 2 is used in which the active surface 9 is arranged in a center plane 27 of the PV module 2, the PV module 2 can be pushed into the receptacle 13 just far enough so that the shading angle 29 acting on the outer edge 30 of the active surface 9 just corresponds to the opening angle 56, as illustrated in FIG. 11.

In contrast, the left half of FIG. 12 shows that the shading angle 29 increases considerably when the active surface 9 moves closer to the module-side end 52 of the module holder 6. This approach initially appears favorable in order to be able to design the active surface 9 as large as possible in relation to the overall size of the PV module 2, i.e., to be able to use a comparatively small cell edge distance 61. However, the disadvantage of a small offset 57 is that the maximum shading-free angles may then be restricted (wherein tolerances must be taken into account when inserting the PV modules 2 into the module holder 6).

The right part of FIG. 12 shows that the shading angle 29 caused by the module holder 6 can even be smaller than the opening angle 56 spanned by the module holder 6, namely if the offset 57 in question is selected to be correspondingly large. However, such a large offset leads to a loss of active surface 9 and thus to lower electricity production. Therefore, said offset 57 should preferably be at most 20% greater than a minimum offset that must be maintained in order to ensure the desired maximum shading-free angle of incidence on the front side 12 or the rear side 11. For example, in FIG. 11, the active surface 9 could be moved somewhat closer to the module-side end 52 if only a maximum shading-free front and rear angle of incidence of 135° is desired.

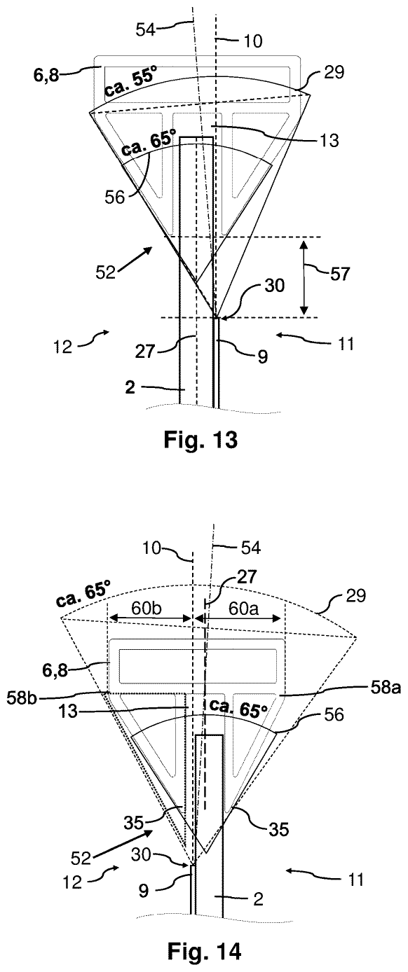

FIG. 13 is based on the example of FIG. 11, however here a PV module 2 is now inserted into the same module holder 6, in which the active surface 9 is laterally offset from the center plane 27 of the PV module 2. In this case, however, a comparatively large maximum shading-free angle of incidence 23, 24 on the front side 12 as well as on the rear side 11 was ensured by selecting a comparatively large offset 57. This also results in a small tilt angle 55 of less than 15° and a comparatively small shading angle of approximately 55°. Such a configuration may be suitable, for example, if a PV module 2 is used, which in any case has a comparatively large cell edge distance 61 (see FIG. 12).

FIG. 14 shows another example of a set designed according to the invention. Here, however, a module holder 6 is used which is asymmetrically designed in relation to the center plane 27 of the PV module 2 shown. As can be seen, however, the lateral distances 60a and 60b between the module plane 10 of the active surface 9 and the respective outer point 58a, 58b of the module holder 6 differ only very slightly. In this case, the fact that the active surface 9 of the PV module 2 is offset towards the front side 12 is at least partially compensated for by the asymmetrical design of the module holder 6, so that a comparatively small shading angle of approximately 65° can still be achieved, with a comparatively small offset 57 between the module-side end 52 of the module holder 6 and the outer edge 30 of the active surface 9.

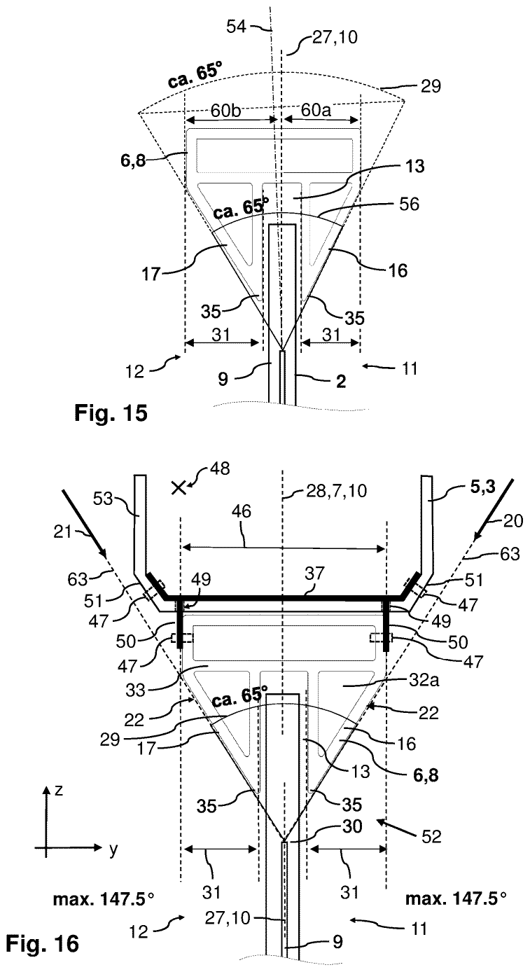

As the example in FIG. 15 shows, an asymmetrically designed module holder 6 can also be used according to the invention with a PV module 2 of which the active surface 9 is positioned centrally in relation to the outer edges/surfaces of the PV module 2. The asymmetry of the module holder 6 can be recognized, for example, by the differently sized lateral extents 31 of the two legs 16 and 17.

All embodiments according to the invention as shown in FIGS. 3 to 9 and 11 to 16 have in common that the module holder 6 used in each case has recessed outer points 58 a and 58b, so that the module-side tips 35 of the two legs 16 and 17 in each case form the module-side end 52, that, furthermore, a maximum angle of incidence of at least 110° without shading is ensured on both the front and rear sides and that the tilt of the respectively set shading angle 29, relative to the plane 10 of the active surface 9, is at most 15° in each case. As a result, a high efficiency of solar electricity production can be achieved in all these exemplary embodiments, both with front and rear irradiation of the bifacial PV module 2.

FIGS. 17 and 18 also show perspective views of a horizontally extending upper transom 5 of a support structure 3 of a PV system 1 according to the invention, wherein the design corresponds to the diagram in FIG. 16. FIGS. 17 and 18 show a fastening element 37, as already explained above, which is inserted into the upwardly half-open transom 5, which is designed by means of a C-profile, in order to fasten the module holder 6 arranged under the transom 5 together with the PV module 2 held by it to the transom 5. FIG. 18 shows the two front tabs 50, which are formed by the fastening element 37 to hold the module holder 6. FIG. 17 also shows that the fastening element 37 forms a support leg 68 at the front and rear, which is supported on the inside of the transom 5 in the mounting position and is screwed to it.

To summarize, for securely holding an upright photovoltaic (PV) module 2, an associated sufficiently strong module holder 6 is proposed, which can stabilize one or more outer edges of the PV module 2 against wind loads and at the same time minimizes the susceptibility of the PV module 2 to shading by the associated module holder 6. For this purpose, it is intended to form the module holder 6 with a convex shape, thereby enabling large maximum shading-free angles of incidence 23, 24 at the front and rear, and at the same time to achieve the lowest possible respective lateral extent of the module holder 6 in a direction transverse to an active surface 9 of the PV module 2, both at the front and at the rear. This makes it possible to obtain powerful PV systems 1 based on a support structure 3 which, with the aid of module holders 6 designed in accordance with the invention, supports large-surface-area bifacial PV modules 2 in an upright position and in a largely shading-free manner.

### LIST OF REFERENCE SIGNS

1 photovoltaic system
2 photovoltaic module
3 support structure
4 post
5 transom
6 module holder (for positioning/holding 2)
7 module plane (formed by several 2s or 9s)
8 hollow profile
9 active surface (of 2)
10 plane of the active surface (i.e., plane of 9)
11 rear side (of 2)
12 front side (of 2)
13 receptacle
14 (outer) edge (of 2)
15 insertion direction (along which 2 can be inserted in 13)
16 rear leg (of 6, defined 13)
17 front leg (of 6, defined 13)
18 push-on direction (in which 6 can be pushed onto 2, opposite to 15)
19 cover/protective layer, in particular designed as an anti-reflective layer
20 incident sun ray (falls on 11)
21 incident sun ray (falls on 12)
22 outer contour (of 6)
23 maximum shading-free angle of incidence (with regard to 11)
24 maximum shading-free angle of incidence (with regard to 12)
25 envelope (of 6, seen in the direction of 15)
26 area normal (to 9 or 10)
27 center plane (of 2 or 6)
28 symmetry plane (of 6)
29 shading angle
30 (outer) edge (of 9)
31 lateral extent (from 16, 17, transverse to 10 and measured from 13)
32 hollow chamber
33 hollow chamber wall (connects 16 and 17)
34 module frame
35 module-side tip (of 16/17)
36 spacing (between 35 and 9)
37 fastening element (for fastening 6/34 to 4/5)
38 long side (of 2/14)
39 transverse die (of 2/14)
40 insertion depth (of 2 in 6/13)
41 minimum width (of 13)
42 joint (between 6/43, to form 34)
43 module holding element
44 partial portion (of 14)
45 insertion opening (of 13, for insertion of 2 into 13)
46 (lateral) total extent (of 6)
47 screw connection
48 longitudinal direction (of 5)
49 push-through opening (formed in 5, for insertion of 37 into 5)
50 tabs (of 37, for fastening 6)
51 bevel (at 5)
52 module-side end (of 6)
53 longitudinal profile
54 bisector (of 29)
55 tilt angle
56 opening angle (of 6)
57 offset (between 30 and 52)
58 outer points (of 6, each laterally spaced from 10)
59 cross-section width (of 52)
60 lateral distance between the module plane and the module holder, in particular lateral cell plane-frame distance (=lateral distance between 58 and 10)
61 cell edge distance (distance between outer edge of 2 and 30)
62 shading length
63 bevel
64 maximum insertion depth (of 13)
65 maximum width (from 6 towards 15)
66 distance (between 14 and stop formed by 6)
67 stabilizing leg
68 contact leg (of 37 for contact with 5)
69 module plane
70 geometric center of gravity (from 32c)
71 wall thickness thickening

1. A set, comprising
a module holder (6);
an associated bifacial photovoltaic module (2), the photovoltaic module (2) has an active surface (9) which can receive sunlight from a front side (12) and from a rear side (11) of the photovoltaic module (2) in order to convert the sunlight into electrical current;
the module holder (6) provides a receptacle (13) into which an outer edge (14) of the photovoltaic module (2) is inserted in an insertion direction (15) and held in position, wherein the receptacle (13), relative to a plane (10) of the active surface (9) of the photovoltaic module (2), is delimited at [[the]] a front by a front leg (17) and/or at a rear by a rear leg (16) of the module holder (6); and
respective front and rear outer points (58a, 58b), which are relevant for determining shading of the active surface (9) by the module holder (6), of a cross-section of the module holder (6) extending perpendicularly to the plane (10) of the active surface (9) are set back in the insertion direction (15) and with respect to respective module-side tips (35) of the two legs (16, 17).

2. The set including the module holder (6) and the associated bifacial photovoltaic module (2) as claimed in claim 1, wherein
an outer contour (22) of the module holder (6) lies within a shading angle (29), which extends in a cross-sectional plane and starts from an outer edge (30) of the active surface (9), with respect to the cross-sectional plane of the module holder (6) extending perpendicularly to the plane (10) of the active surface (9), and
an angle bisector (54) of the shading angle (29) with the plane (10) of the active surface (9) encloses a tilt angle (55) of at most 15°,

3. The set as claimed in claim 2,
wherein the shading angle (29) is at most 100°, 90°.

4. The set including the module holder (6) and the associated bifacial photovoltaic module (2) as claimed in claim 1, wherein
an outer contour (22) of the module holder (6) is designed such that both
a maximum shading-free angle of incidence (23) at which an incident sun ray (20) is adapted to reach an outer edge (30) of the active surface (9) from the front side (12), as well as
a maximum shading-free angle of incidence (24) at which an incident sun ray (21) is adapted to reach the outer edge (30) of the active surface (9) from the rear side (11), in each case, measured in relation to the active surface (9), is at least 110°, preferably at least 120°, particularly preferably at least 135°.

5. The set as claimed in claim 1, wherein the front leg and the rear leg (16, 17) of the module holder (6) form a respective outer contour (22) which remains within an imaginary or actual bevel (63) which runs towards a module-side insertion opening (45) of the receptacle

(13) and
the respective bevel (63) forms an angle to the active surface (9) of at least 110°.

6. The set as claimed in claim 1 wherein the front leg and the rear leg (16, 17) of the module holder (6) each have a lateral extent (31), transverse to a center plane (27) of the photovoltaic module (2) and in each case measured from the receptacle (13), which is at least 25% of a minimum width (41) of the receptacle (13) in a direction of a surface normal (26) of the active surface (9) .

7. The set as claimed in claim 1, wherein the first leg and the second leg (16, 17) of the module holder (6) are part of a hollow profile (8) that forms
the entire module holder (6), and
the hollow profile (8) forms a closed hollow chamber wall which delimits a hollow chamber (32c), and a module plane (69), in which the active surface (9) of the photovoltaic module (2) extends, extends through this hollow chamber (32c).

8. The set as claimed in claim 1, wherein the module holder (6) comprises a module holding element (43) which embraces only a partial portion (43) of the circumferential outer edge (14) of the photovoltaic module (2) or supports at least on one side.

9. The set as claimed in claim 1, further comprising
at least four module holders (6a, 6b, 6c, 6d) which together form a module frame (34) surrounding the photovoltaic module (2),
wherein the module holders (6a, 6b, 6c, 6d) are joined together at several joints (42) to form the module frame (34).

10. The set as claimed in claim 1, wherein the outer edge (14) of the photovoltaic module (2) in the receptacle (13) is at least one of:
a) held clamped,
b) adhered an adhesive tape, or
c) glued sealingly by a sealing compound (41).

11. The set as claimed in claim 2, wherein a tip (35) of the front leg (17) and/or of the rear leg (16) forms module-side end (52) of the module holder (6), and
the module-side end (52) lies within the shading angle (29).

12. A photovoltaic system (1), comprising:
a support structure (3) on which a plurality of bifacial photovoltaic modules (2) are arranged upright,
the support structure (3) has a plurality of posts (4) which are fastened to or in the ground, and transoms (5) are fastened to the posts (4) and in each case connect two adjacent ones of the posts (4) to one another,
the set including the module holder (6) and the associated bifacial photovoltaic module (2) as claimed in claim 1, and
the photovoltaic modules (2) are each fastened to the support structure (3) by the at least one respective module holder (6).

13. The photovoltaic system (1) as claimed in claim 12, wherein the module holder (6) is fastened to at least one of the posts (4), below one of the transoms (5), above one of the transoms (5).

14. The photovoltaic system (1) as claimed in claim 12, wherein the support structure (3) comprises the transoms (5), on an underside of which the module holder (6) of one of the sets (1) is suspended, and/or comprises the transoms (5), on an upper side of which the module holder (6) of one of the sets (1) is fastened, and
a cross-section of the respective transom (5), which extends transversely to a longitudinal direction (48) of the transom (5), is selected such that a respective maximum shading-free angle of incidence (23, 24), at which a respective incident sun ray (20, 21) is adapted to reach the active surface (9) of the photovoltaic module (2) from the front side (12) or from the rear side (11), is defined by an outer contour (22) of the module holder (6).

15. The photovoltaic system (1) as claimed in claim 14 wherein said transoms (5) on the underside of which one of the sets (1) is mounted are formed by a longitudinal profile (53) which is half-open at a top thereof, and
individual fastening elements (37) are inserted into push-through openings (49) on the underside of transoms (5) in order to fasten the module holder (6) of one of the sets (1) arranged under the transom (5) to the transom (5), and/or.

16. A set, comprising
a module holder (6);
an associated bifacial photovoltaic module (2), the photovoltaic module (2) has an active surface (9) which can receive sunlight from a front side (12) and from a rear side (11) of the photovoltaic module (2) in order to convert the sunlight into electrical current;
the module holder (6) provides a receptacle (13) into which an outer edge (14) of the photovoltaic module (2) is inserted in an insertion direction (15) and held in position, wherein the receptacle (13), relative to a plane (10) of the active surface (9) of the photovoltaic module (2), is delimited at a front by a front leg (17) and/or at a rear by a rear leg (16) of the module holder (6);
an outer contour (22) of the module holder (6) lies within a shading angle (29), which extends in a cross-sectional plane and starts from an outer edge (30) of the active surface (9), with respect to the cross-sectional plane of the module holder (6) extending perpendicularly to the plane (10) of the active surface (9); and
an angle bisector (54) of the shading angle (29) with the plane (10) of the active surface (9) encloses a tilt angle (55) of at most 15°.

17. The set according to claim 6, wherein a width of the receptacle (13) increases in the insertion direction (15), and/or the center plane (27) of the photovoltaic module (2) is laterally offset from a center plane of the receptacle (13) or from a center plane (27) of the module holder (6).

18. The set according to claim 7, wherein at least one of:
a) a geometric center of gravity (70) of the hollow chamber (32c) has a lateral distance transverse to the module plane (69) which is less than 25% of a lateral extent of the hollow chamber (32c) transverse to the module plane (70),
b) the hollow chamber (32c) follows the receptacle (13) in the insertion direction (15),
c) the hollow profile (8) has a wall thickness thickening (71) in a region of the receptacle (13), which thickening lies in the module plane (69), or
d) the module holder (6) has at a module-side end (52) thereof a cross-sectional width (59) transverse to the insertion direction (15), which corresponds at most to a sum of the minimum width (41) of the receptacle (13) and twice a material thickness (56) of the hollow profile (8).

19. The set according to claim 8, further comprising a plurality of said module holding elements (34), each of which embraces or supports at least on one side partial portions (43) of the outer edge (14).

20. The photovoltaic system (1) as claimed in claim 15, wherein the fastening elements (37) form respective lugs (50) on front and rear sides, to which the module holder (6) of the associated set (1) is mounted.
